(19) United States
(12) Patent Application Publication
(10) Pub. No.: US 2009/0085804 A1
(43) Pub. Date: Apr. 2, 2009

(54) GPS positioning and returning device

(76) Inventor: Lien-Chen Lin, Jhubei City (TW)

Correspondence Address: Raymond Sun, 12420 Woodhall Way, Tustin, CA, 92782, US

(21) Appl. No.: 12/002,660

(22) Filed: Dec. 18, 2007

(30) Foreign Application Priority Data
Oct. 2, 2007 (TW) 096216419

(51) Int. Cl. G01S 5/00

(52) U.S. Cl. 342/357.08

(57) ABSTRACT

A GPS positioning and returning device is provided. The GPS positioning and returning device comprises a compass, a GPS module, an input interface, a memory, a display module and a control module. A marked direction on the GPS positioning and returning device pointing to the cardinal point of North on the compass is a reference direction. Through an input from the input interface, a first control signal is generated. The first control signal is received by the GPS module through the control module so as to generate first coordinates; the first coordinates are then stored in the memory. The input interface may further input a second control signal. The second control signal is received by the GPS module so as to generate second coordinates. After a relative direction and distance between the first coordinates and second coordinates are calculated, the display module is driven to display the relative direction and distance.

### BACKGROUND OF INVENTION

1. Field of the Invention

The present invention relates to a GPS positioning and returning device; particularly, it relates to a GPS positioning and returning device utilizing a GPS module to calculate a relative direction and distance with respect to initial coordinates and current coordinates and to present the relative direction and distance on the display module.

2. Description of the Prior Art

In metropolitan cities, parking is a major problem to many people. Most of them search for a parking space or a parking lot around a destination; however, the parking space or parking lot may be having a distant to the destination such that a driver may forget the exact location of the parked car when returning thereto. Furthermore, as to the elder with worsened memory or young children with less identification capability, it is easy for them to get lost when they are to return home and thus causing trouble for their family and the society. As a result, the cost to the society is increased. Even people doing outdoor activities or mountain climbing may sometimes forget where the car is parked, or where the camp is set and thus creates problems.

Although a variety of GPS positioning navigation devices on the market combines the map and the satellite positioning function, these devices rely on built-in navigation software and map as well as a GPS satellite positioning on the map. The cost is relatively high and the technology is relatively complex. Thus, the GPS devices are mostly utilized in the car, and they are expensive purchases and hard to operate. An advanced hardware is needed to drive the positioning software and thus making it hard to be adopted by general consumers. Additionally, the conventional GPS positioning navigation devices on the market are mostly used in a particular area that can be displayed and covered by built-in maps. For those outdoor or mountain climbing people, the built-in map of the conventional GPS positioning navigation devices cannot display where the car is parked, or where the camp is set. In other words, the conventional GPS positioning navigation device on the market can only display the user's absolute coordinate at a time, and cannot display the user's relative direction and distance to an initial point. As a result, the parked car, camp or returning road cannot be located.

### SUMMARY OF INVENTION

An object of the present invention is to provide a GPS positioning and returning device capable of receiving satellite coordinates through a GPS module and pointing a relative direction and distance between the current position and a location to be returned to by a display module.

In order to achieve the aforementioned object, a GPS positioning and returning device is provided in the present invention. The GPS positioning and returning device comprises a compass, a GPS module, an input interface, a memory, a display module and a control module. A marked direction on the GPS positioning and returning device pointing to the cardinal point of North on the compass is a reference direction. Through an input from the input interface, a first control signal is generated. The first control signal is received by the GPS module through the control module so as to generate first coordinates; the first coordinates are stored in the memory. The input interface may further input a second control signal. The second control signal is received by the GPS module so as to generate second coordinates. After a relative direction and distance between the first coordinates and second coordinates are calculated, the display module is driven to display the relative direction and distance.

In a preferred embodiment, the GPS positioning and returning device further comprises a timing module automatically activated after the second coordinates are obtained such that the control module automatically generates a plurality of N^{th} coordinates in sequence from the coordinates signals received from the GPS module and storing the plurality of N^{th} coordinates in the memory, and a relative direction and distance between a most current position of the N^{th} coordinates and the first coordinates calculated by the control module such that the display module displays the relative direction and distance.

In a preferred embodiment, the display module further comprises a plurality of LED modules, a display screen, a GPS positioning indicator and a power indicator. The LED modules are separated at a predetermined angle and evenly distributed around the compass so as to display a relative direction in conjunction with the compass. The display screen is provided at a predetermined location on the GPS positioning and returning device so as to display the relative distance calculated. The GPS positioning indicator is flickering at a predetermined frequency when a positioning of the GPS module is activated so as to notify whether the positioning is complete. The power indicator is continuously lighting when activated and flickering when the power module is insufficient to provide power under a normal operation.

In a preferred embodiment, the control module further comprises a GPS coordinates calculating module, a comparison module and a display control module. The GPS coordinates calculating module quantifying the coordinates signals received to calculate as coordinates and storing the coordinates in the memory. The comparison module compares the two coordinates. The display control module displays the relative direction and distance between the two coordinates on the display module.

In a preferred embodiment, the GPS positioning and returning device further comprises a cell phone function and displays the relative direction and distance in terms of a pointed direction, text, numeric directly on the display module.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a system structural view of the GPS positioning and returning device in accordance with the present invention;

FIG. 2 is an appearance schematic view of the GPS positioning and returning device in accordance with the present invention;

FIG. 3 is a system flow chart of the GPS positioning and returning device in accordance with the present invention;

FIG. 4 is an embodiment of the GPS positioning and returning device combined with a cell phone in accordance with the present invention.

### DETAILED DESCRIPTION

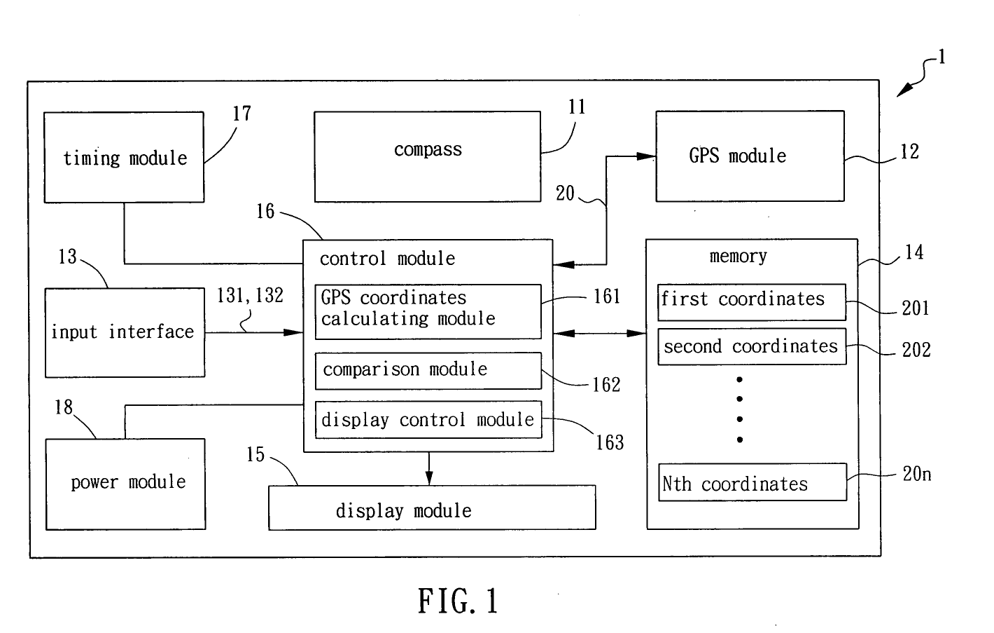

Refer to FIG. 1, which illustrates a system structural view of the GPS positioning and returning device in accordance with the present invention. The GPS positioning and returning device 1 comprises a compass 11, a GPS module 12, an input interface 13, a memory 14, a display module 15, a control module 16, a timing module 17 and a power module 18.

The compass 11 is provided on the GPS positioning and returning device 1 so as to position the cardinal point of North as the reference direction. When pointing to the returned point, the compass 11 adjusts the angle and direction of the GPS positioning and returning device 1 to the north such that the direction pointed by the display module 15 of the GPS positioning and returning device 1 can use the cardinal point of North as the reference direction to display the returned direction. At the same time, under the conditions of the reference direction, the direction and distance relative to the initial point can be accurately directed so as to provide the user with the easy identification of the returned direction and relative distance.

The GPS module 12 is used to receive satellite signals so as to generate at least one coordinate signal 20. The GPS module 12 can consecutively receive satellite positioning signals transmitted by at least one satellite (usually more than three). The control module 16 may store the signals in the memory 14. Since the compass 11 and the GPS module 12 are not the features of the present invention and are utilized in the conventional technology available on the market; thus, the details thereof will not be described hereinafter.

The input interface 13 is used to receive an input operation from the user and to generate a corresponding first control signal 131. The first control signal 131 generates first coordinates 201 as the initial position through the control module 16 as the GPS module 12 receives the coordinate signal 20 and stores it in the memory 14. The input interface 13 can further input a second control signal 132 and generates second coordinates 202 as the current position as the GPS module 12 receives the coordinate signal 20 and stores it in the memory 14. The control module 16 may calculate a relative direction and distance between the second coordinates 202 and the first coordinates 201, and then the display module 15 may present the relative direction and distance. The input interface 13 may be one of a button or a keyboard.

The memory 14 is responsible for storing the coordinates 201, 202. The memory 14 may be one of re-writable non-volatile memory, flash memory, electric programmable read only memory (EPROM), and micro-HD. The memory 14 of the present invention is a conventional product and available on the market. It is not a feature of the present invention and thus will not be described in detail hereinafter.

The display module 15 can at least visually display a direction and distance. The control module 16 automatically activates the timing module 17 after obtaining the second coordinates 202, namely the current position, and automatically generates a new timing signal after a predetermined interval so as to facilitate the GPS module 12 to automatically generate a plurality of N^{th} coordinates 20n (n=3, 4, 5, . . . N) in sequence, namely the current position, timely. At the same time, the coordinates are stored in the memory 14, and overwrite the second coordinates 202 stored in the memory 14 according to the sequence, thereby updating the data with the coordinates of the most current position. As a result, the control module 16 calculates the relative direction and distance between the most current N^{th} coordinates 20n and the first coordinates 201 to allow the display module 15 to present the relative direction and distance.

The control module 16 further comprises a GPS coordinates calculating module 161, a comparison module 162 and a display control module 163. The coordinate signal 20 is obtained through the GPS module 12. The GPS coordinates calculating module 161 quantifies the coordinate signal 20 and stores it in the memory 14. In other words, the first coordinates 201, namely the initial position, the second coordinates 202, namely the current position, and the N^{th} coordinates 20n, namely the most current position, are stored in the memory 14. The comparison module 162 then compares the first coordinates 201, namely the initial position, with the second coordinates 202, namely the current position, or the N^{th} coordinates 20n, namely the most current position. The display control module 163 can then display the direction and the distance of the second coordinates 202, namely the current position, or the N^{th} coordinates 20n, namely the most current position, relative to the first coordinates 201, namely the initial position, on the display module 15, based on the reference direction of the cardinal point of North positioned on the compass 11. As a result, the user is provided with a returned direction reference to the first coordinates 201, namely the initial position.

The power module 18 may provide the power needed by the GPS module 12, the input interface 13, the memory 14, the display module 15, the control module 16 and the timing module 17. The power module 18 may be any one of a lithium battery, a nickel-metal hydride battery, an oxyride battery, a carbon-zinc battery, a nickel-cadmium battery, a fuel battery, and a rechargeable battery.

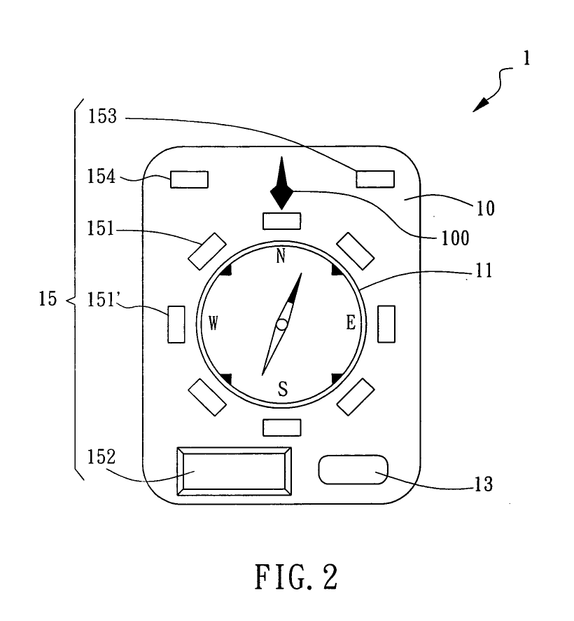

Refer to FIG. 2, which illustrates an appearance schematic view of the GPS positioning and returning device in accordance with the present invention. An operating panel 10 of the GPS positioning and returning device 1 is defined with a marked direction 100. The compass 11, the input interface 13 and the display module 15 are provided on the operating panel 10. The display module 15 may further comprise a plurality of LED modules 151, 151′, a display screen 152, a GPS positioning indicator 153 and a power indicator 154.

In a preferred embodiment of the present invention, the plurality of LED modules 151, 151′ is separated at a predetermined angle and evenly distributed around the compass 11, substantially surrounding eight directions, namely North East, East, South East, South, South West, West, North West and North of the compass 11. In other words, an LED module 151 is provided at an interval of 45 degrees around the compass 11 and used in conjunction with the compass 11 to display the returned direction.

The input interface 13 can be manually pressed for approximately 3 seconds so as to activate the GPS positioning and returning device 1, and at the same time activates the GPS module 12 to start receiving satellite signals. At this time, the GPS positioning indicator 153 and the power indicator 154 are both lit to indicate to the user that it is in a pending position. By consecutively pressing the input interface 13 twice, the first coordinates 201 are set as the initial position, and the plurality of LED modules 151 at the eight directions surrounding the compass 11 will flicker approximately twice every second for three consecutive seconds to indicate to the user that the inputted first coordinates 201 are recorded and stored in the memory 14. After the first coordinates 201, namely the initial position, are set, the input interface 13 can be manually pressed for approximately 3 seconds so as to shutdown the GPS positioning and returning device 1 without deleting the first coordinates 201 stored in the memory 14.

When the user wishes to return to the previously set first coordinates 201, namely the initial position, the input interface 13 may be activated in the same manner as mentioned above. The input interface 13 may be pressed consecutively twice so as to generate second coordinates 202, namely the current position, and at the same time, the plurality of LED modules 151 at the eight directions surrounding the compass 11 may flicker twice every second and continue flickering for three seconds in the same manner so as to indicate to the user that the input is complete and recorded in the memory 14. When the second coordinates 202 are obtained, the timing module 17 as shown in FIG. 1 is automatically activated and generates a timing signal at a predetermined interval, such as every 10 seconds or every 30 seconds or every minute, etc., so as to facilitate the GPS module 12 to generate new coordinates 20n and store the coordinates in the memory 14, overwriting the second coordinates 202 so as to update the most current position.

When the GPS positioning and returning device 1 is to lead from the second coordinates 202, namely the current position, or the N^{th} coordinates 20n, namely the most current position, back to the first coordinates 201, namely the initial position, the marked direction 100 defined on the operating panel 10 is first adjusted to the vertical line extended from the pointing direction of the compass 11 provided on the GPS positioning and returning device 1 such that the GPS positioning and returning device 1 faces North such that the North is set as the reference direction. Thus, the correct returned direction can be led by the plurality of LED modules 151 surrounding the eight directions of the compass 11 after the relative direction is calculated. The direction pointed by the flickering LED module 151 can be identified by the marks on the compass 11, and the display screen 152 can display the relative distance between the current position and the initial position.

When any one of the LED modules 151 at the eight directions is lit, it means the first coordinates 201, namely the initial position, is located approximately at the direction extended from the flickering LED module 151; if two adjacent LED modules 151, 151′ flicker at the same time, then it means the first coordinates 201, namely the initial position, is located approximately at the direction extended from the middle of the two flickering LED modules 151, 151′.

The comparison module 162 of the control module 16 allows the relative distance between the second coordinates 202, namely the current position, or the N^{th} coordinates 20n, namely the most current position, and the first coordinates 201, namely the initial position, to work in conjunction with the LED module 151 around the compass 11 to flicker so as to lead the return direction. It can also be configured such that the LED module 151 is flickered every three seconds when the distance is beyond 2 km. The LED module 151 is flickered once every two seconds when the distance is within 1˜2 km; the LED module 151 is flickered once every second when the distance is within 0.1˜1 km; the LED module 151 is flickered once every 0.3 second when the distance is within 0.1 km.

The display screen 152 may be provided in a predetermined location on the operating panel 10 so as to update the relative distance between the second coordinates 202, namely the current position, or the N^{th} coordinates 20n, namely the most current position, and the first coordinates 201, namely the initial position, calculated by the control module 16 on the display screen 152 in real time. The display screen 152 may be one of a liquid crystal display or a numeral LED light set.

The GPS positioning indicator 153 flickers once every second when the GPS module 12 positioning is activated, and flickers twice every second when the positioning is complete. Different flickering frequencies are set to indicate to the user whether the positioning is complete. The power indicator 154 may be a red LED module to continue lighting up when the GPS positioning and returning device 1 is activated. When the power module 18 of the GPS positioning and returning device 1 is insufficient to provide operating voltage normally, the power indicator 154 flickers once every second, so as to notify the user that the power module 18 needs to be recharged or that a replacement of a battery is needed.

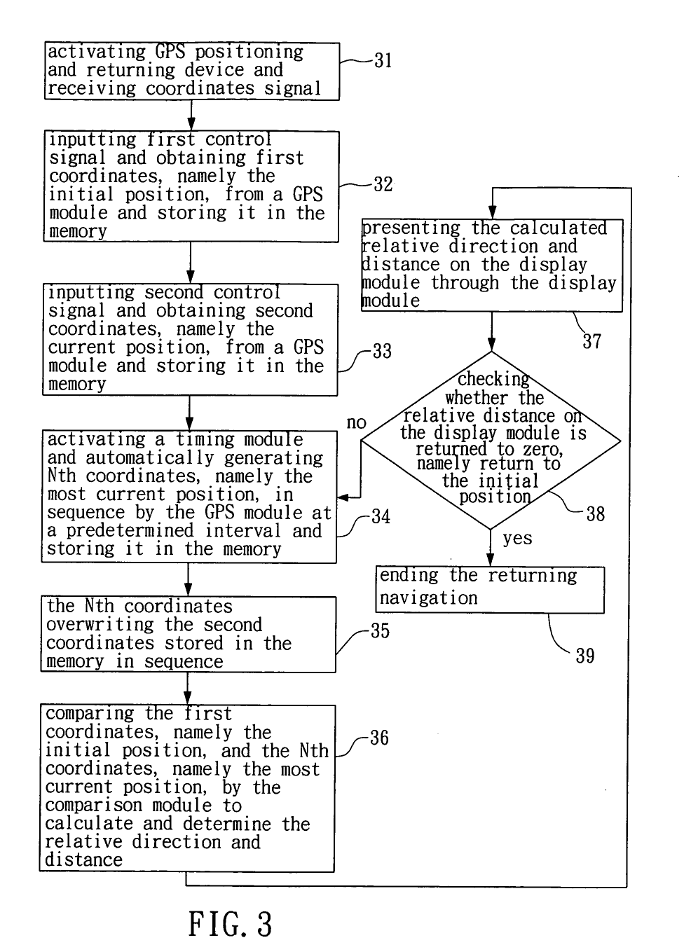

Refer to FIG. 3, which illustrates a system flow chart of the GPS positioning and returning device in accordance with the present invention; wherein, the steps of the GPS positioning and returning device in accordance with the present invention comprise:

Step 31: providing a GPS positioning and returning device and activating a GPS module to receive coordinates signals;

Step 32: generating a corresponding first control signal by an input to an input interface and obtaining the first coordinates, namely the initial position, through a control module, and storing it in the memory;

Step 33: generating a corresponding second control signal by an input to the input interface, obtaining second coordinates, namely the current position, through a control module, and storing it in the memory;

Step 34: activating a timing module by the control module in real time, generating a plurality of N^{th} coordinates, namely the most current position, in sequence within a predetermined interval automatically by the GPS module, and storing them in the memory;

Step 35: overwriting the second coordinates stored in the memory by the N^{th} coordinates, namely the most current position, in sequence so as to update the data with the coordinates of the most current position;

Step 36: calculating and determining a relative direction and distance by a comparison module of the control module comparing the first coordinates, namely the initial position, stored in the memory and the N^{th} coordinates, namely the most current position;

Step 37: presenting the relative direction and distance calculated by the control module on a display module;

Step 38: checking whether the relative distance of the display module is returned to zero, namely returning to the initial position; if so, then performing step 39; if not, then performing step 34; and

Step 39: ending the return navigation, and resetting the GPS positioning and returning device to clear the coordinates stored in the memory.

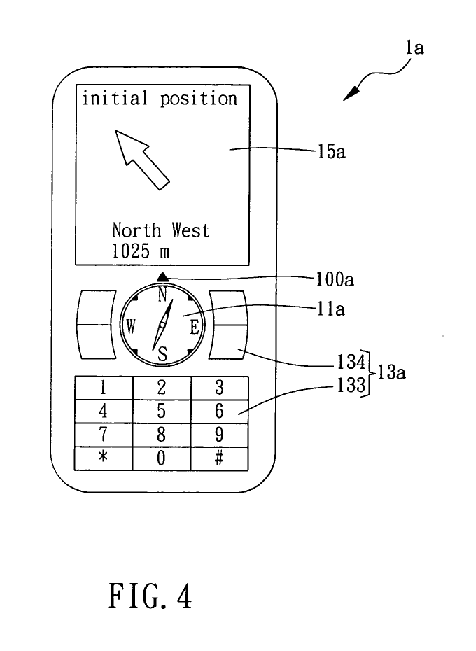

In addition to the dedicated device designed as shown in FIG. 2, the GPS positioning and returning device of the present invention may also be implemented in conjunction with a cell phone. Refer to FIG. 4, which illustrates an embodiment of the GPS positioning and returning device used in conjunction with the cell phone in accordance with the present invention. In the embodiment of FIG. 4, the GPS positioning and returning device 1a of the present invention combines the functions of a cell phone, and has an appearance of the cell phone. In addition to the elements and functions of a conventional cell phone, the GPS positioning and returning device 1a also comprises: a marked direction 100a, a compass 11a, an input interface 13a and a display module 15a, etc., wherein, functions and operating method of the marked direction 100a and the compass 11a are the same as those in the embodiment shown in FIG. 2, and thus will not be described in detail hereinafter. The input interface 13a may comprise a numerical keypad 133 and functional button 134 commonly used in a conventional cell phone; the display module 15a may be a LCD display screen used by the conventional cell phone. In the embodiment of FIG. 4, the calculated relative direction and distance between the first coordinates, namely the initial position, and the N^{th} coordinates, namely the most current position, are directly displayed in the display module 15a in terms of pointed direction, text (numeric) or other pictures, in conjunction with the compass 11a so as to point the correct direction.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A GPS positioning and returning device, comprising:
a compass providing a reference direction for positioning direction;
a GPS module receiving satellite signals so as to generate at least one coordinate signal;
an input interface receiving an input from a user and generating a corresponding first control signal and a corresponding second control signal;
a memory;
a display module capable of at least visually presenting a direction and a distance; and
a control module receiving said first control signal and generating first coordinates according to said coordinates signal received from said GPS module, and then storing said first coordinates in said memory; said control module also receiving said second control signal and generating said second coordinates according to said coordinates signal, and then calculating a relative direction and distance between said second coordinates and said first coordinates by said control module so as to drive said display module to display said relative direction and distance.

2. The GPS positioning and returning device of claim 1, further comprising a timing module automatically activated after said second coordinates are obtained such that said control module automatically generates a plurality of N^{th} coordinates in sequence from said coordinates signals received from said GPS module and storing said plurality of N^{th} coordinates in said memory, and a relative direction and distance between a most current position of said N^{th} coordinates and said first coordinates calculated by said control module such that said display module displays said relative direction and distance.

3. The GPS positioning and returning device of claim 1, wherein an operating panel of said GPS positioning and returning device is defined with a marked direction adjusted to a vertical line extended from a pointing direction of said compass such that said GPS positioning and returning device is pointed to a cardinal point of North as a reference direction.

4. The GPS positioning and returning device of claim 1, wherein said input interface is chosen from one of the following: a button and a keyboard.

5. The GPS positioning and returning device of claim 1, wherein said memory is chosen from one of the following: re-writable non-volatile memory, flash memory, electric programmable read only memory (EPROM) or micro-HD.

6. The GPS positioning and returning device of claim 1, wherein said display module further comprises:
a plurality of LED modules evenly distributed around said compass and separated at a predetermined angle, displaying a relative direction in conjunction with said compass;
a display screen provided at a predetermined location on said GPS positioning and returning device so as to display said relative distance calculated;
a GPS positioning indicator flickering at a predetermined frequency when a positioning of said GPS module is activated so as to notify whether said positioning is complete; and
a power indicator continuously lit when activated and flickering when said power module is insufficient to provide power under a normal operation.

7. The GPS positioning and returning device of claim 1, wherein said control module further comprises:
a GPS coordinates calculating module quantifying said coordinates signals received to calculate as coordinates and storing said coordinates in said memory;
a comparison module comparing said two coordinates; and
a display control module displaying said relative direction and distance between said two coordinates on said display module.

8. The GPS positioning and returning device of claim 1, wherein said power module is chosen from one of the following: a lithium battery, a nickel-metal hydroxide battery, an oxyride battery, a carbon-zinc battery, a nickel-cadmium battery, a fuel battery and a rechargeable battery.

9. The GPS positioning and returning device of claim 6, wherein said plurality of LED modules are surrounded at North East, East, South East, South, South West, West, North West and North of said compass.

10. The GPS positioning and returning device of claim 6, wherein said display screen is chosen from one of the following: liquid crystal display and numerical LED lights.

11. The GPS positioning and returning device of claim 1, wherein said GPS positioning and returning device further comprises a cell phone function and displays said relative direction and distance in terms of a pointed direction, text, numeric directly on said display module.

12. A GPS positioning and returning device, comprising:
a compass providing a reference direction of positioning direction;
a GPS module receiving at least one satellite signal and generating at least one coordinates signal;
an input interface receiving an input from an user and generating a corresponding first control signal;
a memory;
a timing module, periodically generating a timing signal;
a display module at least visually displaying a direction and a distance; and
a control module receiving said first control signal and generating first coordinates according to said coordinates signal received from said GPS module and storing said first coordinates in said memory, and then receiving said timing signals and generating N^{th} coordinates according to said coordinates signal, and then calculating a relative direction and distance between said N^{th} coordinates and said first coordinates by said control module so as to drive said display module to display said relative direction and distance.

13. The GPS positioning and returning device of claim 12, wherein an operating panel of said GPS positioning and returning device is defined with a marked direction adjusted to a vertical line extended from a pointing direction of said compass such that said GPS positioning and returning device is pointed to a cardinal point of North as a reference direction.

14. The GPS positioning and returning device of claim 12, wherein said display module further comprises:
a plurality of LED modules evenly distributed around said compass and separated at a predetermined angle, displaying a relative direction in conjunction with said compass;
a display screen provided at a predetermined location on said GPS positioning and returning device so as to display said relative distance calculated;
a GPS positioning indicator flickering at a predetermined frequency when a positioning of said GPS module is activated so as to notify whether said positioning is complete; and
a power indicator continuously lit when activated and flickering when said power module is insufficient to provide power under a normal operation.

15. The GPS positioning and returning device of claim 14, wherein said plurality of LED modules are surrounded at North East, East, South East, South, South West, West, North West and North of said compass.

16. The GPS positioning and returning device of claim 12, wherein said control module further comprises:
a GPS coordinates calculating module quantifying said coordinates signals received to calculate as coordinates and storing said coordinates in said memory;
a comparison module comparing said two coordinates; and
a display control module displaying said relative direction and distance between said two coordinates on said display module.

17. The GPS positioning and returning device of claim 12, wherein said GPS positioning and returning device further comprises a cell phone function and displays said relative direction and distance in terms of a pointed direction, text, numeric directly on said display module.
